(19) United States
(12) Patent Application Publication
(10) Pub. No.: US 2015/0279498 A1
(43) Pub. Date: Oct. 1, 2015

(54) TRANSPARENT CONDUCTIVE THIN FILM ELECTRODES, ELECTRONIC DEVICES AND METHODS OF PRODUCING THE SAME

(71) Applicant: Samsung Electronics Co., Ltd., Suwon-Si (KR)

(72) Inventors: Kwang Hee KIM, Seoul (KR); Hyeon Cheol PARK, Hwaseong-si (KR); Chan KWAK, Suji-gu (KR); Yoon Chul SON, Hwaseong-si (KR); Sang Mock LEE, Yongin-si (KR)

(21) Appl. No.: 14/617,459

(22) Filed: Feb. 9, 2015

(30) Foreign Application Priority Data
Mar. 27, 2014 (KR) 10-2014-0036167

(51) Int. Cl. H01B 1/02; C03C 17/36; H01B 1/06; H01B 1/08; H01B 1/12

(52) U.S. Cl. CPC H01B 1/02; H01B 1/026; H01B 1/08; H01B 1/127; H01B 1/128; H01B 1/125; H01B 1/06; C03C 17/3671; C03C 17/3639

(57) ABSTRACT

A transparent electrodes having a conductive thin film, an electronic devices including the same, and methods of producing the same, include a first metal layer and a second metal layer on the first metal layer, wherein a surface energy of the first metal layer is higher than a surface energy of the second metal layer.

### CROSS-REFERENCE TO RELATED APPLICATION

This application claims priority to and the benefit of Korean Patent Application No. 10-2014-0036167 filed in the Korean Intellectual Property Office on Mar. 27, 2014, the entire contents of which are incorporated herein by reference.

### BACKGROUND

1. Field

Example embodiments relate to transparent conductive thin film electrodes, production methods thereof, and electronic devices including the same.

2. Description of the Related Art

Electronic devices such as flat panel displays (e.g., a liquid crystal display and a light emitting diode display), touch screen panels, photovoltaic cells, and transparent transistors include transparent electrodes. Materials for the transparent electrode may have high transmittance (for example, of at least 70%) in the range of a wavelength of about 380 nm to about 780 nm, and a low level of sheet resistance, for example, of about 100 ohm/sq or lower or of about 50 ohm/sq or lower. These materials may be utilized in different applications depending on their sheet resistance values. For example, the materials having a sheet resistance of about 300 ohm/sq or higher may find their utilities in antistatic films and electrodes for touch screen panels, and the materials having a sheet resistance of about 20 to about 50 ohm/sq may be used in transparent electrodes for displays such as flexible displays and E-papers. In addition, the materials having a sheet resistance of about 10 ohm/sq or less have great potential for photovoltaic cells, electrodes for a light-emitting diode, and the like.

The currently available materials for the transparent electrode include indium tin oxide (ITO), tin oxide (SnO₂), zinc oxide (ZnO), and the like. The ITO is an n-type semiconductor having an increased concentration of electrons due to the presence of SnO₂. Electrical and optical characteristics of the ITO may depend on defects in a crystalline In₂O₃ structure. The ITO may exhibit a satisfactory level of light transmission, but have a sheet resistance of greater than about 100 ohm/sq especially when it is formed by vapor deposition at room temperature. In addition, the ITO tends to have poor flexibility, and limited reserves of indium may lead to an increasing cost thereof so that an urgent need to develop a material that may substitute for the ITO still remains. Therefore, it is desirable to develop materials for transparent electrodes that may exhibit higher transmittance and a lower level of sheet resistance.

### SUMMARY

Some example embodiments of the present disclosure relate to transparent electrodes having high conductivity and excellent light transmittance.

Some example embodiments of the present disclosure relate to an electronic device including the foregoing transparent electrode.

According to some example embodiments of the present disclosure, a transparent electrode is provided, which includes a first metal layer and a second metal layer on the first metal layer, wherein a surface energy of the first metal layer is higher than a surface energy of the at least one second metal layer.

The first metal layer may be on a transparent substrate including at least one selected from the group consisting of an inorganic oxide, quartz, a polymer, a semiconductor material, a crystalline material, an organic-inorganic hybrid material, and a combination thereof.

The transparent electrode may further include a transparent oxide layer, a transparent conductive polymer, or a transparent conductive carbon material layer, and the transparent oxide layer, the transparent conductive polymer, or the transparent conductive carbon material layer may be on the second metal layer.

The first metal layer may include a metal having a surface energy of greater than, or equal to, about 1300 mJ/cm² at about 0° C.

The first metal layer may include at least one selected from the group consisting of W, Mo, Cu, Au, Cu, Pd, and a combination thereof.

The first metal layer may have a thickness of less than, or equal to, about 2 nm.

The second metal layer may include at least one selected from the group consisting of Ag, Cu, Au, Al, and a combination thereof.

The second metal layer may have a thickness of less than, or equal to, about 10 nm.

The second metal layer may have a thickness of less than, or equal to, about 5 nm.

The transparent oxide layer, the transparent conductive polymer layer, or the transparent conductive carbon material layer may include a material having a dielectric constant of greater than, or equal to, about 10.

The transparent oxide layer, the transparent conductive polymer layer, or the transparent conductive carbon material layer may include a material having a specific resistance of less than, or equal to, about 1×10⁻² Ω·cm.

The transparent oxide layer may include a compound having a bandgap of greater than, or equal to, about 3.0 eV.

The transparent oxide layer may include at least one selected from the group consisting of an indium oxide, a Sn doped indium oxide, a zinc oxide, an Al doped ZnO, a tin oxide doped with Ga or In, or Zn, Ga₂O₃, SiO₂, Al₂O₃, GaN, AlN, MoO₃, WO₃, GaN, and a combination thereof.

The transparent conductive polymer layer may include at least one selected from the group consisting of polythiophene, polyaniline, polyparaphenylene, polypyrrole, polyacetylene, and a combination thereof.

The transparent conductive carbon material layer may include at least one selected from the group consisting of carbon nanotubes, graphene, a reduced graphene oxide, graphite, and a combination thereof.

The transparent oxide layer may have a thickness of less than, or equal to, about 100 nm.

The transparent oxide layer may have a thickness of less than, or equal to, about 70 nm.

Other example embodiments of the present disclosure relate to a method of producing a transparent electrode including a first metal layer and a second metal layer on the first metal layer, wherein a surface energy of the first metal layer is higher than a surface energy of the at least one second metal layer, the method including obtaining a transparent substrate; forming the first metal layer on the transparent substrate; and forming the second metal layer on the first metal layer.

The method may further include forming a transparent oxide layer, a transparent conductive polymer layer, or a transparent conductive carbon material layer on the second metal layer.

The forming of the transparent oxide layer, the transparent conductive polymer layer, or the transparent conductive carbon material layer on the second metal layer may be performed in a non-oxidative atmosphere.

The first metal layer may include at least one selected from the group consisting of W, Mo, Cu, Au, Cu, Pd, and a combination thereof, the second metal layer may include at least one selected from the group consisting of Ag, Cu, Au, Al, and a combination thereof, the first metal layer may have a thickness of less than, or equal to, about 2 nm, and the second metal layer may have a thickness of less than, or equal to, about 10 nm.

Further example embodiments of the present disclosure relate to an electronic device including the aforementioned transparent electrode.

The electronic device may be a flat panel display, a touch screen panel, a photovoltaic cell, an e-window, a heat mirror, or a transparent transistor.

The aforementioned transparent electrode may exhibit a low level of sheet resistance and high transmittance even when it is prepared via vapor deposition at room temperature. For example, the transparent electrode based on a metal thin film even having a thickness of less than 10 nm may exhibit a sheet resistance of less than, or equal to, about 100 ohm/sq, and a transmittance of greater than, or equal to, about 80% (a glass substrate subtracted). In addition, without any increase in the thickness of the metal layer of silver (Ag), a metal layer having enhanced continuity may be prepared by improving the surface morphology of the metal layer. In addition, if desired, while the decrease in the transmittance may be minimized, the thickness of the metal layer (e.g., a silver layer) may increase, which makes it possible to achieve a sheet resistance of about 10 ohm/sq. In particular, a low level of sheet resistance (for example one order lower than that of ITO) may be realized at room temperature without heating a substrate. In addition, when the thin metal film has a polymeric dielectric as coated on its surface instead of the ITO, the resulting electrode may show great flexibility and thus may be utilized in the application requiring a small radius of curvature.

### BRIEF DESCRIPTION OF THE DRAWINGS

Example embodiments will be more clearly understood from the following detailed description taken in conjunction with the accompanying drawings. FIGS. 1-6 represent non-limiting, example embodiments as described herein.

FIG. 1 is a view schematically illustrating a structure of a transparent electrode according to some example embodiments.

FIG. 2 is a view schematically illustrating a structure of a transparent electrode according to other example embodiments.

FIG. 3 is a view schematically illustrating a structure of a transparent electrode according to still other example embodiments.

FIG. 4 is a view schematically illustrating a structure of a transparent electrode according to further example embodiments.

FIG. 5 shows curves plotting transmittance over a wavelength for some transparent electrodes prepared in Example 1.

FIG. 6 shows curves plotting transmittance over a wavelength for some transparent electrodes prepared in Example 2.

### DETAILED DESCRIPTION

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various features will be described in detail with reference to the attached drawings. However, example embodiments described are not limited thereto.

Example embodiments relate to transparent conductive thin film electrodes, production methods thereof, and electronic devices including the same.

In some example embodiments, a transparent electrode includes a first metal layer and a second metal layer being disposed on the first metal layer, wherein a surface energy of the first metal layer is higher than that of the second metal layer. The transparent electrode may further include a transparent metal oxide layer being disposed on the second metal layer.

The first metal layer may be disposed on a substrate, the substrate including an inorganic oxide, quartz, a polymer, a semiconductor material, a crystalline material, an organic-inorganic hybrid material, or a combination thereof. The substrate may include an electrically insulating inorganic oxide (e.g., silica or glass), an electrically conductive inorganic oxide (e.g., ITO, ZnO, a tin oxide, a gallium oxide, or TiO₂; quartz); a polymer (e.g., polystyrene, polycarbonate, polyolefin, polyethylene terephthalate, or polyimide); a semiconductor material (e.g., Si or Ga); a crystalline material (e.g., a single crystal or a polycrystal); or an organic-inorganic hybrid material. The substrate may be transparent.

The currently available ITO electrode has good light transmittance. However, when being vapor-deposited at room temperature, the ITO has a sheet resistance of greater than about 100 ohm/sq. The ITO may show a sheet resistance of about 20 ohm/sq to about 30 ohm/sq only when it is vapor-deposited on a substrate and heated to a high temperature such as 350° C. or higher. A metal thin film electrode may secure a certain degree of transmittance when it has a thickness of less than a skin depth, but the metal thin film electrode still suffers a severe decrease in transmittance in the longer wavelength range. In addition, it is not easy to form a metal thin film having such a small thickness. The metal thin film may show higher transmittance as its thickness decreases, but a smaller thickness inevitably causes a sharp increase in sheet resistance. For example, when silver is formed as a thin film having a thickness of about 10 nm, the resulting film may have a low sheet resistance of about 5 ohm/sq to about 10 ohm/sq, but its transmittance is less than 55% and 50% to light having a wavelength of about 550 nm and to the whole range of visible light, respectively, making it impossible to be used in a transparent electrode.

Therefore, the currently available technologies cannot provide an electrode having low sheet resistance together with sufficiently good transmittance. A multi-layered structure of an oxide-metal-oxide (OMO) was suggested as an alternative measure. The OMO structure is obtained by laminating metal (Ag or Cu) thin layers having a thickness of about 10 nm with a metal oxide layer. The OMO structure may use a low level of sheet resistance of the metal and optimize the reflection and the refraction by the combination of the oxide and metal layers to realize higher transmittance of light than that of the metal thin film electrode. However, the OMO structure may have an increased transmittance comparable to that of the ITO only within a narrow wavelength range, and it fails to obtain high transmittance in such a wide wavelength range as the ITO. In addition, it is still difficult to form a metal thin film with a sufficiently small thickness without a defect on the metal oxide layer.

In contrast, the transparent electrodes of the aforementioned example embodiments have the foregoing structure so that they may address the problems such as high sheet resistance of the ITO, poor light transmittance and poor sheet resistance of the metal thin film electrode, and a narrow wavelength range of light transmittance of the OMO structure.

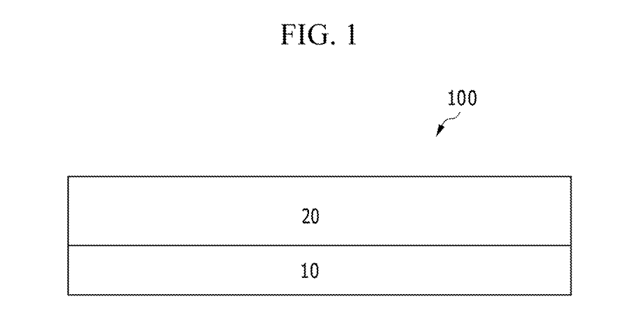

Specifically, FIG. 1 is a view schematically illustrating a structure of a transparent electrode according to some example embodiments.

Referring to FIG. 1, a transparent electrode 100 according to some example embodiments may have a first metal layer 10 having a small thickness (hereinafter, the first metal layer) and a second metal layer 20 that is in contact with the first metal layer and has a surface energy lower than that of the first metal 10 (hereinafter, the second metal layer). The first metal layer 10 has a higher surface energy than the second metal layer 20.

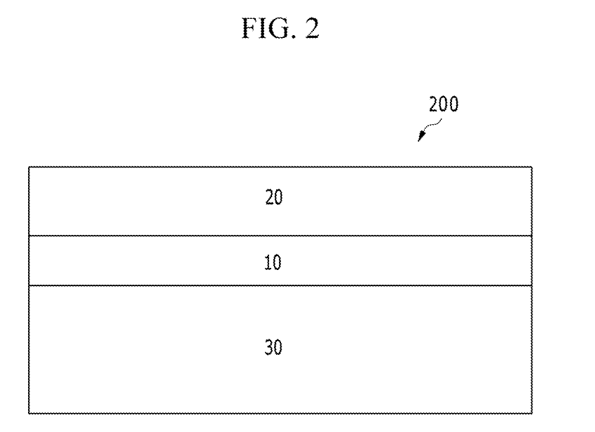

FIG. 2 is a view schematically illustrating a structure of a transparent electrode according to other example embodiments.

Referring to FIG. 2, in transparent electrode 200, the first metal layer 10 may be disposed on a substrate 30. The substrate 30 may a glass substrate, or a plastic substrate.

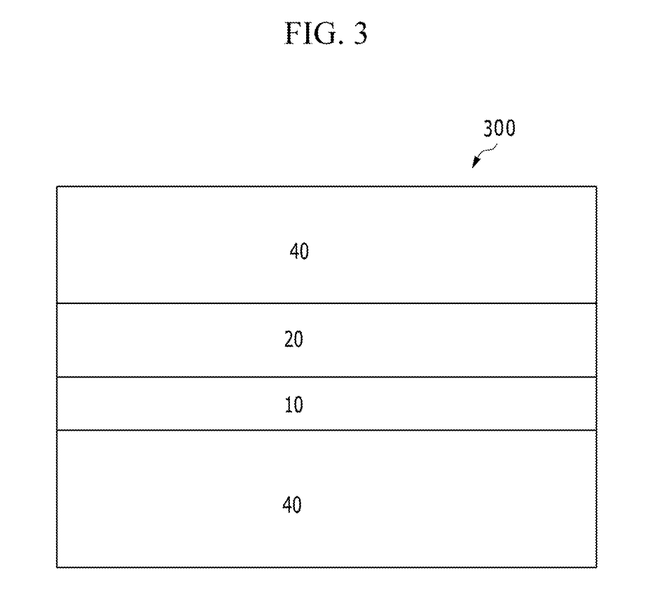

FIG. 3 is a view schematically illustrating a structure of a transparent electrode according to still other example embodiments.

Referring to FIG. 3, in transparent electrode 300, a first metal layer may be disposed on a transparent oxide layer 40. The transparent oxide layer 40 may be formed of (or include) ITO, ZnO, SnO₂, Ga₂O₃, or TiO₂. A second metal layer 20 may be formed on the first metal layer 10 and on the second metal layer 20, another transparent oxide layer 40 may be formed.

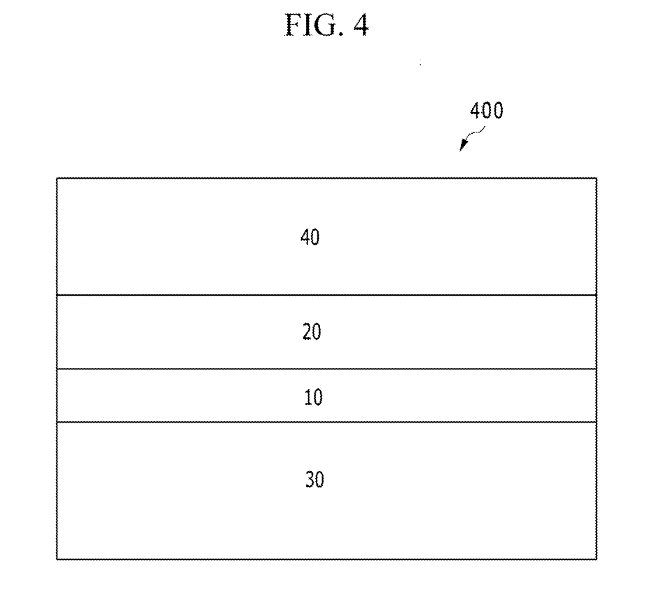

FIG. 4 is a view schematically illustrating a structure of a transparent electrode according to further example embodiments.

Referring to FIG. 4, in transparent electrode 400, the first metal layer 10 may be disposed between the substrate 30 made of a glass, a plastic, or the like, and the second metal layer 20. The transparent oxide layer 40 may be disposed on the second metal layer 20. The transparent oxide layer 40 may be a transparent metal oxide layer (e.g., ITO, ZnO, SnO₂, Ga₂O₃, TiO₂, and the like), a transparent conductive polymer layer (e.g., polythiophene, polyaniline, polyparaphenylene, polypyrrole, polyacetylene, or the like), or a transparent conductive carbon material layer (e.g., carbon nanotubes, graphene, a reduced graphene oxide, a graphite, or the like).

The first metal layer 10 may include a metal having a surface energy of greater than, or equal to, about 1300 mJ/cm², for example, greater than, or equal to, about 1500 mJ/cm², at a temperature of 0° C. The first metal layer 10 may include W, Mo, Cu, Au, Cu, Pd, or a combination thereof. The first metal layer 10 may have a thickness of less than, or equal to, about 2 nm, for example, less than, or equal to, about 1 nm. The second metal layer 20 may include Ag, Al, Cu, Au, or a combination thereof. The second metal layer 20 may have a thickness of less than, or equal to, about 10 nm, for example, less than, or equal to, about 9 nm, less than, or equal to, about 8 nm, less than, or equal to, about 5 nm, or less than, or equal to, about 4 nm.

According to other example embodiments, the first metal layer 10 and the second metal layer 20 may be formed of the same metal (e.g., Au), and the first metal layer 10 may include particles, pigments and/or modifiers at the surface thereof, which cause the first metal layer 10 to have a greater surface energy than the second metal layer 20.

The transparent metal oxide layer, the transparent conductive polymer layer, or the transparent conductive carbon material layer may include a material having a specific resistance of less than, or equal to, about 1×10⁻² Ω·cm, for example, less than, or equal to, about 1×10⁻³ Ω·cm. The transparent oxide layer 40 may have a dielectric constant of greater than, or equal to, about 10. The transparent metal oxide may include an indium oxide, a Sn doped indium oxide (e.g., the ITO), a zinc oxide (e.g., ZnO), a Group III element doped ZnO (e.g., a ZnO doped with aluminum, a ZnO doped with gallium, etc.), a tin oxide, a tin oxide doped with Ga, In, and/or Zn, Ga₂O₃, SiO₂, Al₂O₃, GaN, AlN, MoO₃, WO₃, GaN, or a combination thereof. The transparent conductive polymer layer may include polythiophene, polyaniline, polyparaphenylene, polypyrrole, polyacetylene, or a combination thereof. The transparent conductive carbon material layer may include carbon nanotubes, graphene, a reduced graphene oxide, graphite, or a combination thereof. The transparent metal oxide layer, the transparent conductive polymer layer, or the transparent conductive carbon material layer may have a thickness of less than, or equal to, about 100 nm, for example, less than, or equal to, about 70 nm. The transparent metal oxide layer, the transparent conductive polymer layer, or the transparent conductive carbon material layer may have a thickness of less than, or equal to, about 50 nm, for example, from about 30 nm to about 50 nm. The transparent metal oxide layer may include a compound having a bandgap of greater than, or equal to, about 3.0 eV, for example, about 3.1 eV or higher, about 3.2 eV or higher, or 3.5 eV or higher.

The transparent electrodes according to example embodiments having the aforementioned structures may exhibit a low level of sheet resistance and a high level of light transmittance at the same time. Surprisingly, when a thin layer of a first metal having high surface energy is formed and then a thin layer of a second metal having a lower surface energy than the first metal is formed thereon, the resulting structure may exhibit good transmittance over a wide wavelength range (for example, over the entire wavelength range or in a long wavelength range) while it maintains a low level of sheet resistance. The thin layer of the first metal may be a continuous layer, or a discontinuous layer (e.g., a seed layer). Without wishing to be bound by any theory, it is believed that the first metal layer may play a role of a seed layer for the formation of the second metal layer, thereby controlling the surface morphology of the second metal layer, and this makes it possible for the transparent electrode thus prepared to have higher transmittance and lower sheet resistance. In other words, the presence of the first metal layer having high surface energy allows for the formation of the second metal layer having a smaller thickness while maintaining enhanced continuity (e.g., having less defects). Accordingly, the combination of high transmittance and low sheet resistance that has been difficult to achieve in the conventional technologies may be achieved. In addition, the transparent electrode having the aforementioned structure may be prepared without heating a substrate during a process such as sputtering, and thus the electrode prepared by vapor deposition at room temperature may exhibit sufficiently good transmittance while it realize sheet resistance being 10 times better than that of the ITO. In addition, when a polymeric dielectric is coated on the second metal layer instead of the ITO, the resulting electrode may have excellent flexibility and may be utilized in applications requiring a small radius of curvature.

The transparent electrode may have a transmittance of greater than, or equal to, about 70%, for example, about 75% with respect to light having a wavelength of 550 nm, while it may exhibit a sheet resistance of less than about 55 ohm/sq., for example, less than about 50 ohm/sq., or less than about 49 ohm/sq.

The transparent electrode having the aforementioned structure may be prepared by sequentially forming the first metal layer and the second metal layer on a substrate via physical vapor deposition such as thermal evaporation, sputtering, or the like, or chemical vapor deposition such as MOCVD, atomic layer deposition (ALD), or a plating method. If desired, a transparent metal oxide layer, a transparent conductive polymer layer, or a transparent conductive carbon material layer may be provided on the second metal layer in any appropriate manner.

In accordance with other example embodiments, a method of producing a transparent electrode includes obtaining a transparent substrate 30; forming a first metal layer 10 on the transparent substrate 30; and forming a second metal layer 20 on the first metal layer 10, wherein the surface energy of the first metal layer 10 is higher than that of the second metal layer 20. The method may further include forming a transparent (metal) oxide layer 40, a transparent conductive polymer layer, or a transparent conductive carbon material layer on the second metal layer.

The types of the substrate are the same as set forth above. The substrate may have any shape.

Details of the first metal layer 10 and the second metal layer 20 are the same as set forth above. Conditions and specific manners for the physical vapor deposition, the chemical vapor deposition, the atomic layer deposition, or the plating method are known in the art. In non-limiting examples, when the first metal layer 10 and/or the second metal layer 20 is formed via sputtering, a metal target and a sputtering gas including an inert gas may be used. The metal target is prepared by any known method or is commercially available. The sputtering may be conducted in any known or commercially available apparatus. In non-limiting examples, the sputtering may be carried out in a magnetron sputtering apparatus equipped with an RF and/or DC power supply, but it is not limited thereto. The inert gas may include argon (Ar), helium (He), neon (Ne), krypton (Kr), or a combination thereof, and for example, it may include argon. The sputtering may be carried out under an atmosphere having a low partial pressure of oxygen (e.g., less than 3×10⁻⁵ torr), for example, under an atmosphere including no oxygen. The temperature of the sputtering is not particularly limited and may be from about 40° C. to about 50° C. The distance between the target and a substrate is not particularly limited, and may be greater than, or equal to, about 5 cm, for example, may range from 10 cm to 30 cm. The sputtering time may be 1 second or longer, for example, 2 seconds or longer, or 5 seconds or longer, but it is not limited thereto. The thickness of the thin film may be controlled by adjusting the sputtering time. The vacuum degree of the sputtering is selected appropriately, and for example, may be less than, or equal to, about 0.1 torr, less than, or equal to, about 0.01 torr, or less than, or equal to, about 0.005 torr, but it is not limited thereto.

After the formation of the second metal layer, the transparent dielectric metal oxide layer, the transparent conductive polymer layer, or the transparent carbon material layer is prepared according to a suitable (known) method of forming a thin film depending on its types. For example, the transparent dielectric metal oxide layer may be formed via thermal evaporation, chemical vapor deposition, spray pyrolysis, sol-gel processing, physical vapor deposition such as pulsed laser deposition or sputtering, a plating method, or the like, but it is not limited thereto. Specific conditions for each method are known in the art. In example embodiments, the formation of the transparent dielectric metal oxide layer, the transparent conductive polymer layer, or the transparent conductive carbon material layer may be carried out under (or performed in) a non-oxidative atmosphere. As used herein, the terminology “under a non-oxidative atmosphere” refers to “in an atmosphere including substantially no oxygen,” or for example, under vacuum or under an inert gas atmosphere.

In other example embodiments, an electronic device including at least one of the transparent electrodes according to the aforementioned example embodiments is provided. Details of the transparent electrode have already been explained above.

The electronic device may be a flat panel display, a touch screen panel, a photovoltaic cell, an e-window, a heat mirror, a transparent transistor, or a flexible display.

The following examples illustrate some example embodiments in more detail. However, it is understood that the scope of the present invention is not limited to these examples.

### EXAMPLES

### Reference Example 1

### Electrodes Having a Second Metal Layer Formed on a Glass Substrate

An electrode including a silver metal layer formed on a glass substrate (E-glass) is prepared by using a RF magnetron sputterer (manufactured by Samhan Vacuum Co. Ltd., model name: SHS-2M3-400(L)) under the following conditions. A preparatory experiment is conducted under the following conditions to determine a sputtering time that is required for vapor deposition of a thin film having a set (or predetermined) thickness, and the results therefrom are used to determine a time for vapor deposition of a thin film having a target thickness.

Sputtering target: a two inch silver target (purchased from RND Korea, Co. Ltd., 99.999%)

Power: 100 W

Sputtering gas: Ar 20 sccm

Chamber pressure: 0.002 torr

Chamber temperature: 30° C.

Temperature of the glass substrate: room temperature

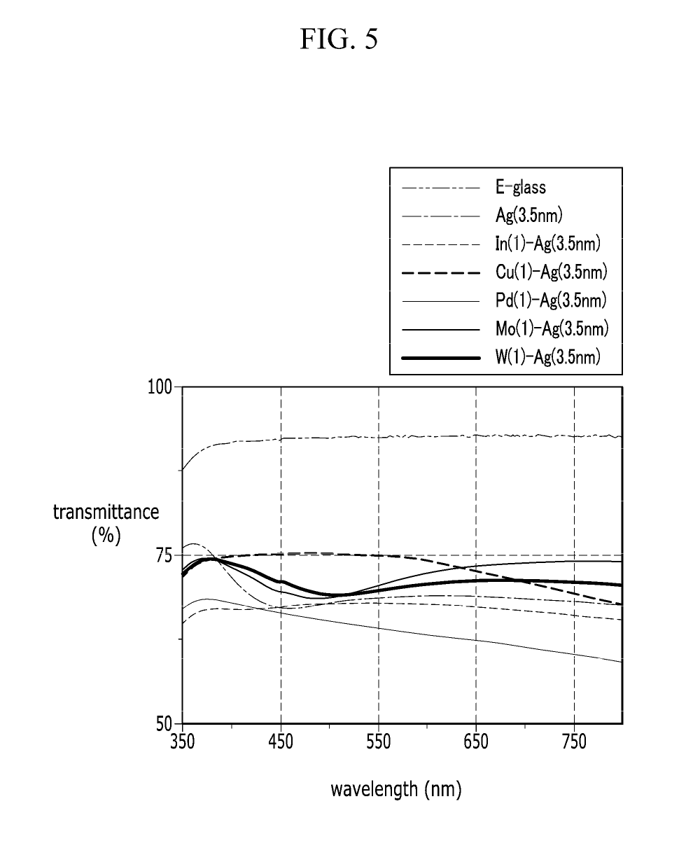

The thickness of the electrode thus prepared is measured using a surface profiler (manufactured by Alpha Step Co., Ltd., model name: P-17), and the results are summarized in Table 1. The sheet resistance of the electrode thus prepared is measured using a Hall effect apparatus (manufactured by Nanometrics Co., Ltd., model name: HL5500PC) in accordance with the 4-probe method, and the results are compiled in Table 1. The light transmittance of the electrode thus prepared is measured using a haze meter (manufactured by Nippon Denshoku, model name: NDH-5000), and the results are summarized in Table 1 and FIG. 5.

### Example 1

### Electrodes Having a First Metal Layer and a Second Metal Layer Formed on a Glass Substrate

A layer of indium (In), copper (Cu), palladium (Pd), molybdenum (Mo), or tungsten (W) as a first metal layer and a silver layer as a second metal layer are sequentially vapor-deposited on a glass substrate to produce an electrode.

The vapor deposition of the first metal layer and the silver layer are made using a RF magnetron sputterer (manufactured by Samhan Vacuum Co. Ltd., model name: SHS-2M3-400(L)) under the following conditions.

Sputtering target: a two inch silver target, a two inch indium (In) target, a two inch copper (Cu) target, a two inch palladium (Pd) target, a two inch molybdenum (Mo) target, or a two inch tungsten (W) target, (purchased from RND Korea, Co. Ltd., 99.999%)

Power: 100 W

Sputtering gas: Ar 20 sccm

Chamber pressure: 0.002 torr

Chamber temperature: 30° C.

Temperature of the glass substrate: room temperature

Sputtering time: 4 to 8 seconds

The surface energy of the silver is 1.2 J/m². The surface energy of the glass substrate and the surface energy of the first metal layer are compiled in Table 1.

The thickness of the electrode thus prepared is measured using a surface profiler (manufactured by Alpha step Co., Ltd., model name: P-17), and the results are summarized in Table 1. The sheet resistance of the electrode thus prepared is measured using a Hall effect apparatus (manufactured by Nanometrics Co., Ltd., model name: HL5500PC) in accordance with the 4-probe method, and the results are compiled in Table 1. The light transmittance of the electrode thus prepared is measured using a haze meter (manufactured by Nippon Denshoku, model name: NDH-5000), and the results are summarized in Table 1 and FIG. 5.

TABLE 1

| Electrode structure | | | | | | |
|---|---|---|---|---|---|---|
| Glass | | | | | | |
| substrate or | Surface | Target | Total | | | |
| types of the | energy of | thickness of | thickness | | | |
| first metal | the first | vapor | (nm, | Transmittance | | |
| layer, target | metal layer | deposition of | measured | at a | | |
| thickness of | or the glass | the second | value by | wavelength | Sheet | Specific |
| the vapor | substrate | metal (Ag) | surface | of 550 nm | resistance | resistance |
| deposition | (J/m²) | layer (nm) | profiler) | (%) | (ohm/sq) | (ohm cm) |
| Glass | ~0.5 | 3.5 | 3.5 | 61.4 | 118 | 2.95 × 10⁻⁵ |
| substrate | | | | | | |
| Glass | ~0.5 | 15 | 15 | 34.6 | 4.63 | 6.95 × 10⁻⁶ |
| substrate | | | | | | |
| In, 1 nm | 0.65 | 3.5 | 5 | 67.8 | 132.3 | 3.97 × 10⁻⁵ |
| In, 1 nm | 0.65 | 15 | 15 | 33.9 | 4.78 | 7.17 × 10⁻⁶ |
| Cu, 1 nm | 1.79 | 3.5 | 5 | 75 | 37.1 | 1.11 × 10⁻⁵ |
| Cu, 1 nm | 1.79 | 15 | 15 | 34.8 | 3.97 | 5.96 × 10⁻⁶ |
| Pd, 1 nm | 2.05 | 3.5 | 5 | 64.1 | 34.7 | 1.04 × 10⁻⁵ |
| Pd, 1 nm | 2.05 | 15 | | | | |
| Mo, 1 nm | 2.91 | 3.5 | 5 | 70.6 | 49.8 | 1.49 × 10⁻⁵ |
| Mo, 1 nm | 2.91 | 15 | 16 | 39.1 | 2.97 | 5.34 × 10⁻⁶ |
| W, 1 nm | 3.26 | 3.5 | 5 | 69.8 | 39.6 | 1.19 × 10⁻⁵ |
| W, 1 nm | 3.26 | | | | | |

The results of Table 1 confirm that the electrode that employs the first layer of a metal (Cu, Pd, Mo, or W) having a higher surface energy than the silver (Ag) may exhibit a significantly lower sheet resistance (e.g., about one third) than that of the electrode that includes the first layer of a metal (In) having a lower surface energy than the silver (Ag). Without wishing to be bound by any theory, it is believed that the first metal layer having the higher surface energy may act as a seed layer for the vapor deposition of the second metal layer, enhancing wetting properties of the silver thin film layer to the substrate and thereby increasing continuity of the thin film due to the surface wetting of the substrate to lower the sheet resistance of the resulting electrode. In Table 1, the sum of the target thicknesses of the first metal layer and the second metal layer does not exactly correspond to the measured value of the total thickness (i.e., the former is less than or greater than the latter), and this may be because the thin film of the first layer may be formed discontinuously or because of a deviation that may occur during the vapor deposition of each layer.

The results of FIG. 5 confirm that the electrode including the first metal layer of high surface energy may have enhanced light transmittance over a wide range toward a longer wavelength (greater than, or equal to, about 550 nm) in comparison with the electrode of the reference example having the silver layer on the glass substrate. When the copper is used as the first metal layer, the resulting electrode shows higher transmittance over almost the entire range of the wavelength in comparison with the electrode of the reference example. When the molybdenum or the tungsten is used as the first metal layer, the resulting electrode shows higher transmittance in the range of the long wavelength in comparison with the electrode of the reference example.

### Example 2

### Electrodes Having a First Metal Layer, a Second Metal Layer, and the ITO Layer Formed on a Glass Substrate

A layer of tungsten (W) as a first metal layer (about 1 nm) and a silver layer as a second metal layer (about 3.5 nm) are sequentially vapor-deposited on a glass substrate. The vapor deposition of the first metal layer and the silver (Ag) layer are carried out using a RF magnetron sputterer (manufactured by Samhan Vacuum Co. Ltd., model name: SHS-2M3-400(L)) under the following conditions.

Sputtering target: a two inch silver target, and a two inch tungsten (W) target, (purchased from RND Korea, Co. Ltd., 99.999%)

Power: 100 W

Sputtering gas: Ar 20 sccm

Chamber pressure: 0.002 torr

Chamber temperature: 30° C.

Temperature of the glass substrate: room temperature

Sputtering time: 4 to 8 seconds.

On the second metal layer, the indium tin oxide (ITO) layer is formed using a RF magnetron sputterer (manufactured by Samhan Vacuum Co. Ltd., model name: SHS-2M3-400(L)) under the following conditions.

Sputtering target: indium thin oxide (the amount of Sn₂O₃=5%, purchased from RND Korea, Co. Ltd., 99.999%)

Power: 100 W

Sputtering gas: Ar 20 sccm

Chamber pressure: 0.002 torr

Chamber temperature: 30° C.

Temperature of the glass substrate: room temperature

Sputtering time: 0 to 10 minutes (when the sputtering is performed for 10 minutes, about 120 nm of the layer can be vapor-deposited). The thickness is determined to be proportional to the sputtering time.

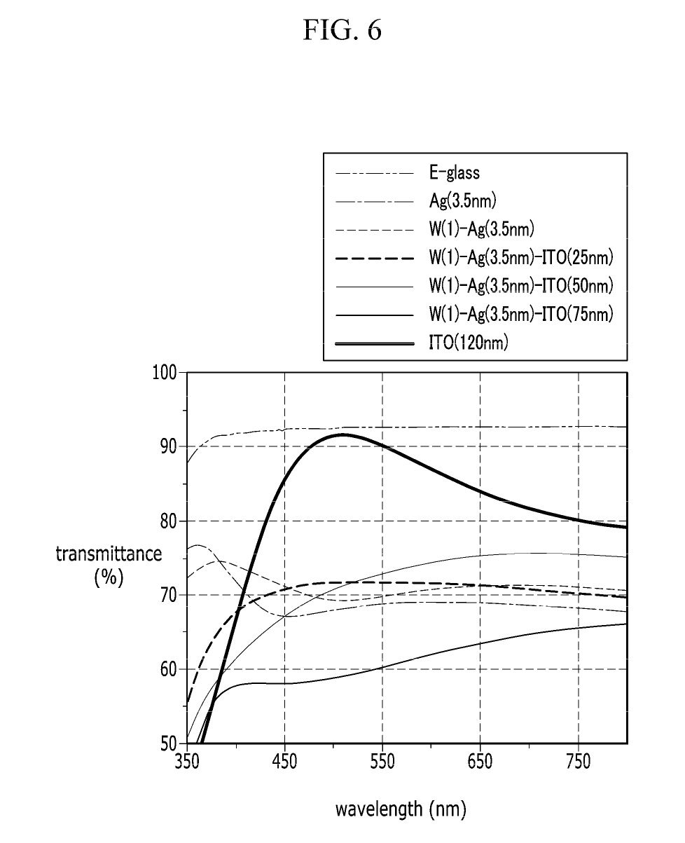

The thickness of the electrode thus prepared is measured using a surface profiler (manufactured by Alpha step Co., Ltd., model name: P-17), and the results are summarized in Table 2. The sheet resistance of the electrode thus prepared is measured using a hall effect apparatus (manufactured by Nanometrics Co., Ltd., model name: HL5500PC) in accordance with the 4-probe method, and the results are compiled in Table 2. The light transmittance of the electrode thus prepared is measured using a haze meter (manufactured by Nippon Denshoku, model name: NDH-5000), and the results are summarized in FIG. 6.

TABLE 2

| Sample composition | | | | |
|---|---|---|---|---|
| Types and target | Target | Thickness | | Sheet |
| thicknesses of the | thickness of the | of the ITO | Thickness | resistance |
| first metal layer | Ag layer (nm) | layer (nm) | (nm) | (ohm/sq) |
| Reference | 3.5 | — | 3.5 | 118 |
| Example (glass) | | | | |
| W, 1 nm | 3.5 | — | 5 | 39.6 |
| W, 1 nm | 3.5 | 25 | 31 | 48.7 |
| W, 1 nm | 3.5 | 50 | 54 | 48.4 |
| W, 1 nm | 3.5 | 75 | 80 | 53.8 |
| — | — | 120 | 120 | 237.8 |

In case of the electrodes of the examples, the indium thin oxide layer having a high dielectric constant and inhibiting the absorption of the surface plasmon of the metal thin layer is formed on the second metal layer.

The results of Table 2 confirm that when the ITO layer is formed, the sheet resistance may slightly increase but the resulting electrodes may have a sheet resistance that is only a half of the sheet resistance (e.g., about 100 ohm/sq.) of the ITO prepared by vapor deposition at room temperature. The results of FIG. 6 confirm that the electrodes of Example 2 (having a thickness of the ITO layer of 25 nm and 50 nm, respectively) may show enhanced light transmittance with respect to the entire range of the wavelength longer than 450 nm in comparison with the electrode of the reference example. However, the electrode of Example 2 may show a decrease in transmittance especially in the range of a short wavelength due to the bandgap (3.5 eV) absorption of the indium tin oxide layer. It is believed that such a decrease may be avoided by using an oxide of a higher bandgap as the transparent oxide.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A transparent electrode, comprising:
a first metal layer and a second metal layer on the first metal layer, wherein a surface energy of the first metal layer is higher than a surface energy of the second metal layer.

2. The transparent electrode of claim 1, wherein the first metal layer is on a transparent substrate including at least one selected from the group consisting of an inorganic oxide, quartz, a polymer, a semiconductor material, a crystalline material, an organic-inorganic hybrid material, and a combination thereof.

3. The transparent electrode of claim 1, wherein the transparent electrode further includes a transparent metal oxide layer, a transparent conductive polymer layer, or a transparent conductive carbon material layer, and
the transparent oxide layer, the transparent conductive polymer layer, or the transparent conductive carbon material layer is on the second metal layer.

4. The transparent electrode of claim 1, wherein the first metal layer includes a metal having a surface energy of greater than, or equal to, about 1300 mJ/cm² at a temperature of about 0° C.

5. The transparent electrode of claim 1, wherein the first metal layer includes at least one selected from the group consisting of W, Mo, Cu, Au, Pd, and a combination thereof.

6. The transparent electrode of claim 1, wherein the first metal layer has a thickness of less than, or equal to, about 2 nm.

7. The transparent electrode of claim 1, wherein the second metal layer includes at least one selected from the group consisting of Ag, Cu, Au, Al, and a combination thereof.

8. The transparent electrode of claim 1, wherein the second metal layer has a thickness of less than, or equal to, about 10 nm.

9. The transparent electrode of claim 3, wherein the transparent metal oxide layer, the transparent conductive polymer layer, or the transparent conductive carbon material layer includes a material having a dielectric constant of greater than, or equal to, about 10.

10. The transparent electrode of claim 3, wherein the transparent metal oxide layer, the transparent conductive polymer layer, or the transparent conductive carbon material layer includes a material having a specific resistance of less than, or equal to, about 1×10⁻² Ω·cm.

11. The transparent electrode of claim 3, wherein the transparent metal oxide layer includes an oxide having a bandgap of greater than, or equal to, about 3.0 eV.

12. The transparent electrode of claim 3, wherein the transparent oxide layer includes at least one selected from the group consisting of an indium oxide, a Sn doped indium oxide, a zinc oxide, an Al doped ZnO, tin oxide doped with Ga, In, or Zn, Ga₂O₃, SiO₂, Al₂O₃, GaN, AlN, MoO₃, WO₃, and a combination thereof;
the transparent conductive polymer layer includes at least one selected from the group consisting of polythiophene, polyaniline, polyparaphenylene, polypyrrole, polyacetylene, and a combination thereof; and
the transparent conductive carbon material layer includes at least one selected from the group consisting of carbon nanotubes, graphene, a reduced graphene oxide, graphite, and a combination thereof.

13. The transparent electrode of claim 3, wherein the transparent oxide layer has a thickness of less than, or equal to, about 100 nm.

14. A method of producing a transparent electrode including a first metal layer and a second metal layer on the first metal layer, wherein a surface energy of the first metal layer is higher than a surface energy of the at least one second metal layer, the method comprising:
obtaining a transparent substrate;
forming the first metal layer on the transparent substrate; and
forming the second metal layer on the first metal layer.

15. The method of claim 14, further comprising:
forming a transparent oxide layer, a transparent conductive polymer layer, or a transparent conductive carbon material layer on the second metal layer.

16. The method of claim 15, wherein the forming of the transparent oxide layer, the transparent conductive polymer layer, or the transparent conductive carbon material layer on the second metal layer is performed in a non-oxidative atmosphere.

17. The method of claim 14, wherein the first metal layer includes at least one selected from the group consisting of W, Mo, Cu, Au, Pd, and a combination thereof,
the second metal layer includes at least one selected from the group consisting of Ag, Cu, Au, Al, and a combination thereof,
the first metal layer has a thickness of less than, or equal to, about 2 nm, and
the second metal layer has a thickness of less than, or equal to, about 10 nm.

18. An electronic device, comprising:
a transparent electrode according to claim 1.

19. The electronic device of claim 18, wherein the electronic device is a flat panel display, a touch screen panel, a photovoltaic cell, an e-window, a heat mirror, or a transparent transistor.
